(19) United States
(12) Patent Application Publication
(10) Pub. No.: US 2005/0161568 A1
(43) Pub. Date: Jul. 28, 2005

(54) Detector installing device

(75) Inventor: Eui Pil Hwang, Seoul (KR)

Correspondence Address: Richard P. Berg;Ladas & Parry, Suite 2100, 5670 Wilshire Boulevard, Los Angeles, CA, 90036, US

(73) Assignee: S1 CORPORATION

(21) Appl. No.: 10/982,501

(22) Filed: Nov. 5, 2004

(30) Foreign Application Priority Data
Jan. 26, 2004 (KR) 10-2004-0004672

(51) Int. Cl. H02G 1/08

(52) U.S. Cl. 248/231.91; 248/222.52

(57) ABSTRACT

A detector installing device includes an attaching member attached on a wall or ceiling; an installing angle adjusting member rotatably mounted on the attaching member; a rotational hook member formed between the attaching member and the installing angle adjusting member; a detector installing member pivotally installed on the installing angle adjusting member; a pivot hook member formed between the installing angle adjusting member and the detector installing member; a fixing shaft integrally coupling the attaching member, the installing angle adjusting member, and the detector installing member to each other while being supported by an elastic member; and a tightening/loosening unit for tightly or loosely coupling the attaching member, the installing angle adjusting member, and the detector installing member to each other by moving the fixing shaft in an advancing direction or a backward direction.

### BACKGROUND OF THE INVENTION

1. Field of the Invention

The present invention relates to a detector installing device, and more particularly, to a detector installing device that is designed to make it easy to install a detector and to adjust an installing angle of a detector mounted on a wall or ceiling.

2. Description of the Related Art

Generally, a heat ray detector used for a security system in a state where it is mounted on a wall or ceiling detects an intruder in a security mode. For installing convenience, a bracket or an installing device is used to install the detector on the wall or ceiling.

As shown in FIG. 1, such an installing device comprises an attaching member 1 attached on a wall/ceiling, an installing angle adjusting member 3, and a detector installing member 5. The installing angle adjusting member 3 is disposed between the attaching member 1 and the detector installing member 5.

Disposed between the attaching member 1 and the installing angle adjusting member 3 is a rotational hook member 7. Disposed between the installing angle adjusting member 3 and the detector installing member 5 is a pivot hook member 9.

The attaching member 1, the installing angle adjusting member 3, and the detector installing member 5 are coupled to each other by the rotational and pivot hook members 7 and 9. A fixing screw 15 penetrates the detector installing member 5, the installing angle adjusting member 3, and the attaching member 1 in this order. The fixing screw 15 further penetrates a retainer 13 installed in the attaching member 1, and a nut 17 is coupled to the fixing screw 15, being biased by an elastic member 11.

That is, before the installing angle is adjusted, the coupling state between the fixing screw 15 and the nut 17 is maintained. Accordingly, the attaching member 1, the installing angle adjusting member 3 and the detector installing member 5 are securely assembled to each other by the fixing screw 15 and the nut 17.

When it is intended to adjust the installing angle, the nut 17 is loosely released from the fixing screw 15 to loosen the assembled state of the attaching member 1, the installing angle adjusting member 3, and the detector installing member 5.

At this point, the engaging state of the rotational hook member 7 and the pivot hook member 9 is also loosened, allowing a rotational motion “a” of the installing angle adjusting member 3 and a pivotal motion “b” of the detector installing member 5.

After the installing angle adjustment is completed, the biasing force of the elastic member 11 maintains an angle position of the attaching member 1, the installing angle adjusting member 3, and the detector installing member 5 that is adjusted by the rotational motion and the pivot motion.

At this point, the rotational hook member 7 and the pivot hook member 9 are in a state of adjustment because of the rotational motion “a” and the pivot motion “b”, and the fixing of the installing angle adjusting member 3 and the detector installing member

In this state, the nut 17 and the fixing screw 15 are tightened up, thereby securely maintaining the assembling state of the attaching member 1, the installing angle adjusting member 3, and the detector installing member 5.

Then, a detector 19 is installed on the detector installing member 5 using a coupling screw 21, thereby completing the installation of the detector 19 at the adjusted angle position.

In the above-described detector installing device, the fixing screw 15 for fixing the attaching member 1, the installing angle adjusting member 3, and the detector installing member 5 to each other is covered by the detector 19, and the detector 19 is fixed on the detector installing member 5 by the coupling screw 21. Therefore, the installing angle is preset and the detector 9 is then installed, making the installing work complicated.

### SUMMARY OF THE INVENTION

Therefore, the present invention has been made in an effort to solve the above-described problem of the prior art.

Accordingly, it is an objective of the present invention to provide a detector installing device that can simplify installation of a detector and adjustment of an installing angle of the detector.

To achieve the objective, the present invention provides a detector installing device comprising an attaching member attached on a wall or ceiling; an installing angle adjusting member rotatably mounted on the attaching member; a rotational hook member formed between the attaching member and the installing angle adjusting member; a detector installing member pivotally installed on the installing angle adjusting member; a pivot hook member formed between the installing angle adjusting member and the detector installing member and having a pivot slot; a fixing shaft integrally coupling the attaching member, the installing angle adjusting member, and the detector installing member to each other while being supported by an elastic member; and a tightening/loosening unit for tightly or loosely coupling the attaching member, the installing angle adjusting member, and the detector installing member to each other by moving the fixing shaft in an advancing direction or a backward direction “d.”

According to an embodiment of the present invention, the tightening/loosening unit comprises an operating shaft provided with a projection having an inclined surface; a lever for rotating the operating shaft; and a cam member having a groove having an inclined surface corresponding to that of the projection of the operating shaft to move the operating shaft in a forward or backward direction to compress or expand the elastic member according to a manipulation of the lever, thereby loosely or tightly coupling the attaching member, the installing angle adjusting member, and the detector installing member to each other using the fixing shaft.

Preferably, the detector installing member is provided with a hook member for coupling the detector thereto.

### BRIEF DESCRIPTION OF THE DRAWINGS

The accompanying drawings, which are included to provide further understanding of the invention and are incorporated in and constitute a part of this application, illustrate embodiment(s) of the invention, and together with the description serve to explain the principles of the invention. In the drawings:

FIG. 1 is a sectional view of a conventional detector installing device;

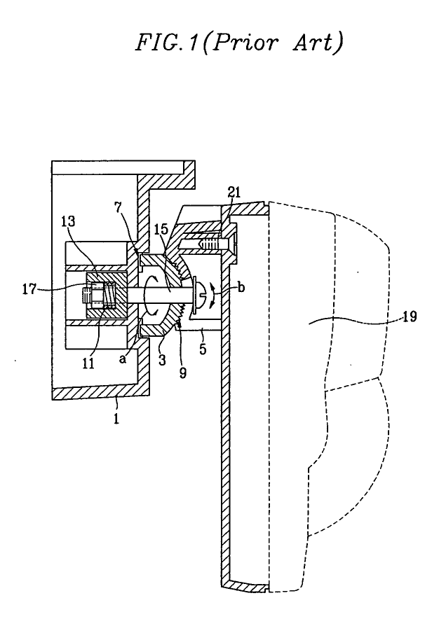

FIG. 2 is a sectional view of a detector installing device according to an embodiment of the present invention; and

FIGS. 3 and 4 are views illustrating an operation of a detector installing device according to an embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

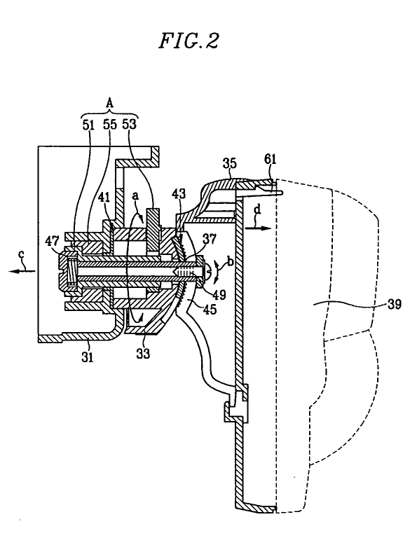

FIG. 2 shows a detector installing device according to an embodiment of the present invention.

As shown in the drawing, the inventive detector installing device comprises an attaching member 31 for attaching a detector 39 on a wall or ceiling, an installing angle adjusting member 33, a detector installing member 35, a fixing shaft 37, and a tightening/loosening unit A.

The attaching member 31 is a major element of the present invention, which is designed to easily install the detector 39 on the wall or ceiling.

The installing angle adjusting member 33 is rotatably installed on the attaching member 31. Disposed between the installing angle adjusting member 33 and the attaching member 31 is a rotational hook member 41. The rotational hook member 41 can be formed of a concave-convex structure or a saw tooth structure that allows opposing surfaces of the installing angle adjusting member 33 and the attaching member 31 to be engaged with each other.

When the installing angle adjusting member 33 is securely coupled to the attaching member 31, the rotational hook member 41 disallows the installing angle adjusting member 33 to rotate in a direction “a.” When the installing angle adjusting member 33 is loosely coupled to the attaching member 31, the rotational hook member 41 allows the installing angle adjusting member 33 to rotate in a direction “a.”

The detector installing member 35 is installed on a side of the attaching member 31 with the installing angle adjusting member 33 interposed between them. A pivot hook member 43 is formed between the detector installing member 35 and the installing angle adjusting member 33. The detector installing member 35 is provided with a pivot slot 45 to pivot in a direction “b.”

When the installing angle adjusting member 33 is tightly coupled to the detector installing member 35, the pivot hook member 43 disallows the detector installing member 35 to pivot in a direction “b.” When the installing angle adjusting member 33 is loosely coupled to the attaching member 31, the pivot hook member 43 allows the detector installing member 35 to rotate in a direction “b.”

As described above, the installing angle adjusting member 33 is mounted on the attaching member 31 to be capable of rotating in the direction “a,” and the detector installing member 35 is mounted on the installing angle adjusting member 33 to be capable of pivoting in the direction “b.” That is, the attaching member 31, the installing angle adjusting member 33, and the detector installing member 35 are integrally coupled to each other by a fixing shaft 37 biased by an elastic member 47.

The elastic member 47 is disposed on a side of the attaching member 31, which is opposite to a side where the detector 39 is disposed, to bias the fixing shaft 37 in an advancing direction “c.” Accordingly, the detector installing member 35 and the installing angle adjusting member 33 that are coupled by a shaft fixing screw 49 screw coupled to the fixing shaft 37 through the detector installing member 35 are securely installed on the attaching member 31 by the biasing force of the elastic member 47.

The tightening/loosening unit A is provided for tightly or loosely coupling the attaching member 31, the installing angle adjusting member 33, and the detector installing member 35 to each other by moving the fixing shaft 37 in the advancing direction “c” or a backward direction “d.”

The tightening/loosening unit A comprises an operating shaft 51, a lever 53, and a cam member 55.

The elastic member 47 is disposed between the operating shaft 51 and the fixing shaft 37. Accordingly, the elastic member 47 is supported on the operating shaft 51, applying the biasing force to the fixing shaft 37. As a result, the attaching member 31, the installing angle adjusting member 33, and the detector installing member 35 are securely assembled to each other by the fixing shaft 37. In addition, the operating shaft 51 is formed of a hollow shaft into which the fixing shaft 37 is inserted, being installed penetrating the attaching member 31 and the installing angle adjusting member 33.

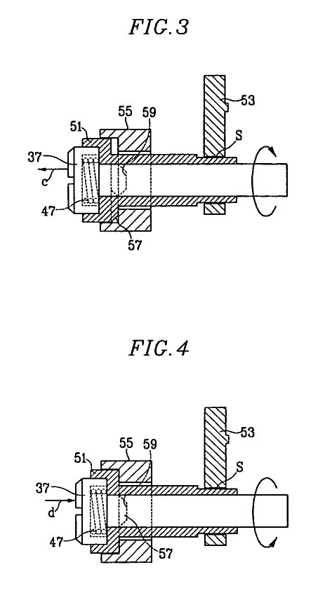

As shown in FIGS. 3 and 4, the operating shaft 51 is provided with a projection 57 having an inclined surface to rotate clockwise or counterclockwise according to the operation of the lever 53, thereby moving in the advancing or backward directions “c” or “d.” In addition, the operating shaft 51 is coupled to the lever 53 with a spline structure “s” so that the lever 53 can maintain its initial position on the installing angle adjusting member 33 when the operating shaft 51 moves in the advancing and backward directions “c”and “d.”

The lever 53 extends out of the installing angle adjusting member 33 to allow a worker to manipulate it.

The projection 57 of the operating shaft 51 reacts relative to a groove 59 of the cam member 55. The groove 59 is formed facing the projection 57 of the operating shaft 51. The operating shaft 51 is disposed penetrating the cam member 55 fixedly mounted on the attaching member 31.

As shown in FIG. 3, when the worker rotates the lever 53 clockwise, the projection 57 of the operating shaft 51 is separated from the groove 59, while rotating clockwise and moving along the inclined surface. As a result, the operating shaft 51 is advanced to compress the elastic member 47, whereby the attaching member 31, the installing angle adjusting member 33, and the detector installing member 35 are tightly coupled to each other by the fixing shaft 37.

In this state, the rotational hook member 41 fixes the attaching member 31 and the installing angle adjusting member 33 to each other while the pivot hook member 43 fixes the installing angle adjusting member 33 and the detector installing member 35 to each other.

As shown in FIG. 4, when the worker rotates the lever 53 counterclockwise, the projection 57 of the operating shaft 51 is engaged with the groove 59, while rotating counterclockwise and moving along the inclined surface of the groove 59. As a result, the operating shaft 51 moves backward to expand the elastic member 47, whereby the attaching member 31, the installing angle adjusting member 33, and the detector installing member 35 are loosely coupled to each other by the fixing shaft 37.

In this state, the rotational hook member 41 allows the installing angle adjusting member 33 to rotate in the direction “a” with respect to the attaching member 31 and the pivot hook member 43 allows the detector installing member 35 to pivot in the direction “b” with respect to the installing angle adjusting member 33, thereby making it possible to easily adjust the installing angle of the detector 39.

Meanwhile, the detector installing member 53 is further provided with a coupling hook member 61 that allows the coupling of the detector 39 to the detector installing member 35 through a one-touch operation.

According to the present invention, the installing angle adjusting member 33 and the detector installing member 35 are tightly or loosely coupled to each other according to the interoperation of the fixing shaft 37, the operating shaft 51, and the cam member 55 in accordance with a simple-manipulation of the lever 53 by a worker, so it becomes more convenient to adjust the installing angle of the detector 39. Furthermore, as the detector installing member 53 is provided with the hook member, the detector can be easily installed on the same.

It will be apparent to those skilled in the art that various modifications and variations can be made in the present invention. Thus, it is intended that the present invention covers the modifications and variations of this invention provided they come within the scope of the appended claims and their equivalents.

1. A detector installing device comprising:
an attaching member attached on a wall or ceiling;
an installing angle adjusting member rotatably mounted on the attaching member;
a rotational hook member formed between the attaching member and the installing angle adjusting member;
a detector installing member pivotally installed on the installing angle adjusting member;
a pivot hook member formed between the installing angle adjusting member and the detector installing member and which has a pivot slot;
a fixing shaft integrally coupling the attaching member, the installing angle adjusting member, and the detector installing member to each other while being supported by an elastic member; and
a tightening/loosening unit for tightly or loosely coupling the attaching member, the installing angle adjusting member, and the detector installing member to each other by moving the fixing shaft in an advancing direction or a backward direction.

2. The detector installing device of claim 1, wherein the tightening/loosening unit comprises:
an operating shaft provided with a projection having an inclined surface;
a lever for rotating the operating shaft; and
a cam member having a groove having an inclined surface corresponding to that of the projection of the operating shaft to move the operating shaft in a forward or backward direction to compress or expand the elastic member according to a manipulation of the lever, thereby loosely or tightly coupling the attaching member, the installing angle adjusting member, and the detector installing member to each other using the fixing shaft.

3. The detector installing device of claim 1, wherein the detector installing member is provided with a hook member for coupling the detector thereto.

4. A detector installing device comprising:
an attaching member attached on a wall or ceiling;
an installing angle adjusting member rotatably mounted on the attaching member;
a rotational hook member formed between the attaching member and the installing angle adjusting member;
a detector installing member pivotally installed on the installing angle adjusting member;
a pivot hook member formed between the installing angle adjusting member and the detector installing member;
a fixing shaft integrally coupling the attaching member, the installing angle adjusting member, and the detector installing member to each other while being supported by an elastic member;
an operating shaft provided with a projection having an inclined surface;
a lever for rotating the operating shaft; and
a cam member having a groove having an inclined surface corresponding to that of the projection of the operating shaft to move the operating shaft in a forward or backward direction to compress or expand the elastic member according to a manipulation of the lever, thereby loosely or tightly coupling the attaching member, the installing angle adjusting member, and the detector installing member to each other using the fixing shaft.
